(19) United States
(12) Patent Application Publication
(10) Pub. No.: US 2010/0165891 A1
(43) Pub. Date: Jul. 1, 2010

(54) LOCAL SIGNAL GENERATOR FOR WIRELESS TELECOMMUNICATION AND LOCAL SIGNAL GENERATION METHOD AND RADIO ACCESS SYSTEM OF WIRELESS TELECOMMUNICATION SYSTEM USING THE SAME

(75) Inventor: Hyun-Jun Lim, Seoul (KR)

Correspondence Address: AMPACC Law Group, 3500 188th Street S.W., Suite 103, Lynnwood, WA, 98037, US

(73) Assignee: POSDATA CO., LTD., Seongnam-si, Kyeonngi-do (KR)

(21) Appl. No.: 12/280,107

(22) PCT Filed: Feb. 23, 2007
(86) PCT No.: PCT/KR2007/000952

§ 371 Date: Aug. 20, 2008

(30) Foreign Application Priority Data
Feb. 28, 2006 (KR) 10-2006-0019218

(51) Int. Cl. H04B 7/005

(52) U.S. Cl. 370/278

(57) ABSTRACT

Disclosed is an apparatus and a method for generating a local signal and a Radio Access Station (RAS) using the same in a wireless telecommunication system. The apparatus includes: an Intermediate Frequency (IF) local unit for generating an IF local signal; and a Radio Frequency (RF) local unit for generating an RF local signal, wherein the IF local unit comprises: a first frequency synthesizer for generating the IF local signal; and a first distributor for distributing the IF local signal into an IF local signal for transmission and an IF local signal for reception, and wherein the RF local unit comprises: a second frequency synthesizer for generating the RF local signal; and a switch for distinguishing the RF signal into an RF local signal for transmission and an RF local signal for reception, and switching the RF local signal for transmission to a transmission path and the RF local signal for reception to a receive path. An optimized circuit configuration is provided so that the local signals for transmission/reception can be generated by a single frequency synthesizer, and the distributor is used instead of the switch in generating the IF local signals for transmission/reception, so that spurious emissions due to the operation of the switch are prevented from occurring, and the characteristic of phase noise can be improved.

### TECHNICAL FIELD

The present invention relates to an apparatus and a method for generating a local signal, and a Radio Access Station (RAS) using the same, in a wireless telecommunication system, and more particularly to an apparatus and a method for generating a local signal, and an RAS using the same, in a wireless telecommunication system, which can optimize the configuration of a circuit by generating a Radio Frequency (RF) local signal for transmission/reception and an Intermediate Frequency (IF) local signal for transmission/reception with a single local unit, outputting the IF local signal with a distributor, and outputting the RF local signal to transmission/receive (Tx/Rx) paths with a switch.

### BACKGROUND ART

With the progress of electronics and communications technology, various services including voice call, data transmission, the internet, etc. are offered via a wireless network, and communication schemes in the wireless network system include a Frequency Division Duplex (FDD) scheme which uses the transmission/receive frequencies different from each other, and a Time Division Duplex (TDD) scheme which uses the same transmission/receive frequency.

Lately, portable internet to which a user can use necessary information by making a high-speed connection in a mobile environment where the user is walking or driving, is coming into wide use, and a general configuration of the portable internet as above is as illustrated in FIG. 1. First, so that the user may be offered portable internet services, a Portable Subscriber Station (PSS) 10 performs authentication of a certification server 40 and the user from an RAS 20 and an Access Control Router (ACR) 30. If the authentication of the user is completed, the user uses the internet with the PSS 10 using a common Internet Protocol (IP) network 60. Herein, an IP network 50 of a common carrier illustrated in FIG. 1 refers to a wire/wireless telecommunication network via which the ACR 30 and the certification server 40 can transmit data.

As illustrated in FIG. 2, the RAS 20 of the portable internet system as described above is configured to include the PSS 10, an antenna 21 for transmitting/receiving a radio signal, a front-end 23 for processing the signal which is transmitted/received to the antenna 21, an amplifier 25 for amplifying the transmission signal, a transceiver 27 for up/down-converting the IF and the RF signals, and a channel control unit 29 for controlling the transceiver 27, checking the transmission/receive signals, and controlling transmission channels. Especially, the transceiver 27 is a device for up/down-converting the transmission/receive signals and is one of the most important configuration elements of the wireless telecommunication system. Hereinafter, a more detailed description will be made relating to the transceiver 27.

As illustrated in FIG. 3, a transceiver 300 of an RAS in a wireless telecommunication system of the FDD scheme includes a local device consisting of a receive-side local unit 310 and a transmission-side local unit 320. Herein, the receive-side local unit 310 is made up of a frequency synthesizer 311, a Band-Pass Filter (BPF) 313, an amplifier 315, a distributor 317, a set of attenuation resistors 319₁ to 319_{L}, etc. The transmission-side local unit 320 is made up of a frequency synthesizer 321, a BPF 323, an amplifier 325, an attenuation resistor 329, etc.

To examine an operation of the receive-side local unit 310, if an output of the frequency synthesizer 311 is output as a receive frequency local signal in synchronization with a reference signal, the receive frequency local signal whose harmonic components are removed in the BPF 313 is amplified by the amplifier 315 in order to have a predetermined magnitude, and then, is input to the distributor 317. The receive frequency local signal provided to the distributor 317 is distributed according to the number of receive paths, and then, the distributed signals are respectively provided through the relevant receive paths. Output levels of the distributed receive frequency local signals are respectively adjusted by the attenuation resistors (R) 319₁ to 319_{L} (here, L corresponds to a natural number) respectively installed on the receive paths. Herein, it is needless to say that the number of receive paths can be set to two or more than two at the request of those skilled in the art.

Also, to inspect an operation of the transmission-side local unit 320, if an output of the frequency synthesizer 321 is output as a transmission frequency local signal in synchronization with a reference signal, the transmission frequency local signal whose harmonic components are removed in the BPF 323 is amplified by the amplifier 325 in order to have a predetermined magnitude. Then, the level of the transmission frequency local signal is adjusted by the attenuation resistor (R) 329.

Thus, in the wireless telecommunication system using the FDD scheme, communicating with each other by using the transmission/receive frequencies different from each other, since each transceiver of the RAS should include the receive-side local unit 310 and the transmission-side local unit 320 in which frequency synthesizers respectively corresponding with the transmission frequency and the receive frequency are separately configured because of the nature of the FDD scheme, the local device consisting of the receive-side local unit 310 and the transmission-side local unit 320 has a large volume, increasing costs, and rising service provision costs due to the use of the transmission/receive frequencies different from each other.

Meanwhile, because an Up Link (UL) and a Down Link (DL) for duplex communications use the same frequency band in the TDD scheme corresponding to one of the communication schemes using in the wireless telecommunication networks, besides technological characteristics such that asymmetrical transmission or burst transmission can be implemented with a dynamic assignment of time slots, there exist merits in that services can be offered with the band 50[%] narrower than the frequency band with which the FDD scheme operates.

### DISCLOSURE OF INVENTION

### Technical Problem

Accordingly, it is an aspect of the present invention to provide an apparatus and a method for generating a local signal in a wireless telecommunication system which transmit/receive data by way of a TDD scheme, particularly configured in a transceiver of an RAS in a portable internet system using the TDD scheme.

It is another aspect of the present invention to provide an apparatus and a method for generating a local signal in a wireless telecommunication system, which prevents spurious emissions from occurring due to switching of an IF local signal, and improves the characteristic of phase noise, in applying the TDD scheme to a portable internet system.

Furthermore, it is another aspect of the present invention to provide an apparatus and a method for generating a local signal in a wireless telecommunication system, which can optimize a circuit configuration of an apparatus for generating a local signal by generating an RF local signal and an IF local signal for transmission/receive from a single local unit, and by switching transmission/receive paths of only the RF local signal.

It is a further aspect of the present invention is to provide an RAS of a wireless telecommunication system using an apparatus and a method for generating a local signal in a wireless telecommunication system, which accomplish the above-mentioned aspects.

### Technical Solution

In accordance with one aspect of the present invention, there is provided an apparatus for generating a local signal in a wireless telecommunication system using a scheme of Time Division Duplex (TDD) according to an embodiment of the present invention, including: an Intermediate Frequency (IF) local unit for generating an IF local signal; and a Radio Frequency (RF) local unit for generating an RF local signal, wherein the IF local unit comprises: a first frequency synthesizer for generating the IF local signal; and a first distributor for distributing the IF local signal into an IF local signal for transmission and an IF local signal for reception, and wherein the RF local unit comprises: a second frequency synthesizer for generating the RF local signal; and a switch for distinguishing the RF signal into an RF local signal for transmission and an RF local signal for reception, and switching the RF local signal for transmission to a transmission path and the RF local signal for reception to a receive path.

It is preferable that the switch switching in synchronization with transmission/receive periods.

Therefore, a configuration of a circuit of an apparatus for generating a local signal can be optimized by outputting the RF local signal with the selection of transmission/receive paths by a switching operation as well as by making it possible to generate transmission/reception local signals with a single frequency synthesizer.

In accordance with another aspect of the present invention, there is provided a method for generating a local signal in a wireless telecommunication system according to an embodiment of the present invention, including the steps of: generating an IF local signal for transmission/reception; and generating a RF local signal for transmission/reception, wherein the step of generating the IF local signal includes the steps of: generating an IF local signal; and distributing the generated IF local signal into the IF local signal for transmission and the IF local signal for reception by a distributor, and wherein the step of generating the RF local signal includes the steps of: generating a RF signal; and switching the generated RF local signal to a transmission/receive path.

In accordance with another aspect of the present invention, there is provided a Radio Access Station (RAS) in a wireless telecommunication system using a scheme of Time Division Duplex (TDD), the RAS comprising: an antenna for transmitting/receiving a Radio Frequency (RF) signal to/from a Portable Subscriber Station (PSS); a front-end for processing transmission/receive signals transmitted/received via the antenna, and transmitting the receive signal to a transceiver; the transceiver for generating an Intermediate Frequency (IF) local signal and an RF local signal, and up/down-converting the RF local signal and an the IF local signal, respectively, by an apparatus for generating a local signal which distributing, by a distributor, the generated IF local signal into an IF local signal for transmission and an IF local signal for reception, and outputting, by a switch, the RF local signal for transmission and the IF local signal for reception; an amplifier for amplifying the transmission signal provided from the transceiver, and transmitting the amplified signal to the front-end; and a channel control unit for controlling the transceiver, checking transmission/reception signals, and controlling a transmission channel.

### ADVANTAGEOUS EFFECTS

According to the present invention, because the local signals for transmission/reception can be generated by a single frequency synthesizer, the size of the apparatus for generating a local signal according to the present invention is not only made smaller, but also it helps to cut down on the cost of the apparatus.

According to the present invention, each distributor distributes the IF local signal to transmission/receive paths without using switches, so that spurious emissions are prevented from occurring due to an operation of the switch, and the characteristic of phase noise can be improved in converting the IF signal into a digital signal.

According to the present invention, transmission/receive paths of the RF local signal are selected by a simple switching operation of a circuit, and accordingly, a circuit configuration of the apparatus for generating a local signal can be optimized.

### BRIEF DESCRIPTION OF THE DRAWINGS

The above and other exemplary features, aspects, and advantages of the present invention will be more apparent from the following detailed description taken in conjunction with the accompanying drawings, in which:

FIG. 1 is a view illustrating a configuration of a general wireless telecommunication system;

FIG. 2 is a block diagram illustrating the primary configuration of the RAS shown in FIG. 1;

FIG. 3 is a block diagram illustrating a configuration of RAS transceiver local unit in a wireless telecommunication system using a scheme of FDD;

FIG. 4 is a block diagram illustrating a configuration of RAS transceiver local unit in a wireless telecommunication system using the scheme of TDD, applied to the present invention;

FIG. 5 is a block diagram illustrating an example in detail of a local signal generating apparatus for wireless telecommunications according to the present invention; and

FIG. 6 is a flowchart illustrating a local signal generating method for wireless telecommunications according to the present invention.

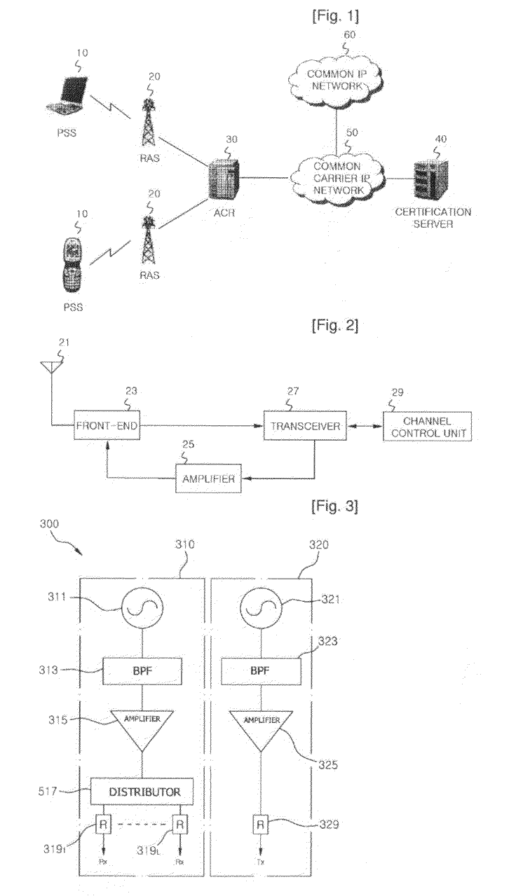

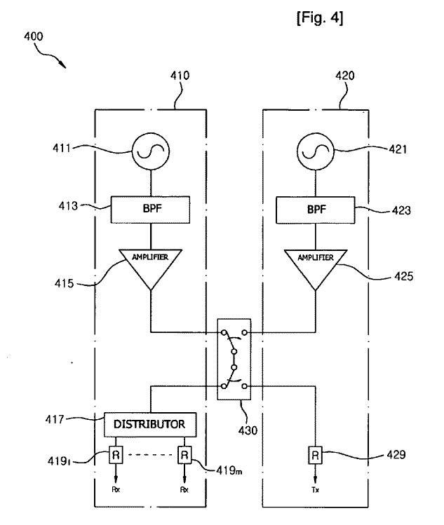

### MODE FOR THE INVENTION

Hereinafter, an exemplary embodiment of the present invention will be described in detail with reference to the accompanying drawings. Well known functions and constructions are not described in detail since they would obscure the invention in unnecessary detail.

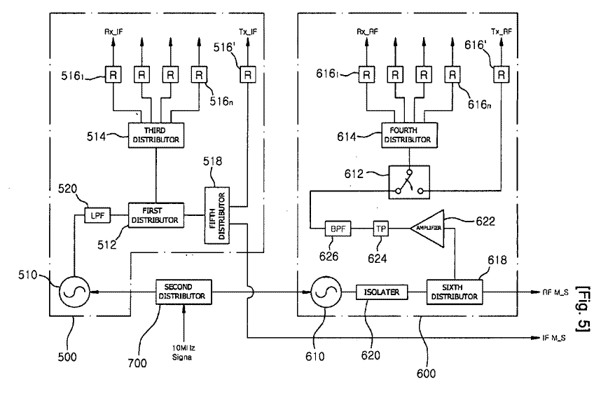

For starters, in a wireless telecommunication system using the TDD scheme, an apparatus 400 for generating a local signal of an RAS transceiver, as illustrated in FIG. 4, includes a receive local unit 410, a transmission local unit 420, and a switch 430.

The receive local unit 410 comprises a frequency synthesizer 411, a Band-Pass Filter (BPF) 413, an amplifier 415, a distributor 417, a set of attenuation resistors 419₁ to 491ₘ, etc. The frequency synthesizer 411 outputs a local signal for reception, the BPF 413 removes harmonic components from the local signal for reception, and the amplifier 415 amplifies the local signal in order to have a specific level. The switching unit 430 switches the local signal to a receive path during a receive period, the distributor 417 distributes the local signal into receive paths. An output level of the local signal for reception may be adjusted by the set of attenuation resistors (R) 419₁ to 491ₘ (here, m corresponds to a natural number), and then the adjusted local signal is output.

The transmission local unit 420 includes a frequency synthesizer 421, a Band-Pass Filter (BPF) 423, an amplifier 425, an attenuation resistor 429, etc. The frequency synthesizer 421 outputs a local signal for transmission, the BPF 423 removes harmonic components from the local signal for transmission, and the amplifier 425 amplifies the local signal in order to have a specified level. The switching unit 430 switches the local signal to a transmission path during a transmission period, the local signal transmission is output via the attenuation resistor 429 for adjusting an output level of the local signal for transmission.

Hence, because the transceiver of the RAS in the wireless telecommunication system using the TDD scheme can control transmission/receive frequencies by a single frequency synthesizer, asymmetrical transmission or burst transmission can be implemented, and accordingly, services can be offered with the band 50[%] narrower than the frequency band with which the FDD scheme operates.

Meanwhile, the local signal is classified into an RF local signal and an IF local signal. An RF signal transmitted/received via an antenna of the RAS is converted into the IF signal having the intermediate frequency between the baseband and the carrier frequency, and the IF signal is used in an interface with a repeater, etc.

Consequently, if the RF signal (e.g., a signal of 2.345 [GHz]) is received from the PSS, an RAS system down-converts the RF signal, with an RF local signal (e.g., a signal of 2.205 [GHz]), into the IF signal (e.g., a signal of 140 [MHz]) used in filtering, etc., for eliminating noises and the like. And the IF signal is down-converted, with an IF local signal (e.g., a signal of 130 [MHz]), into a signal (e.g., a signal of 10 [MHz]) having the frequency for processing digital signal. In a case of transmission, each IF local signals are up-converted in reverse order in the case of the above reception. Namely, the RF local signal is used for up/down-converting the RF signal and the IF signal, and the IF local signal is used for up/down-converting the IF signal and a digital signal.

In a case where the apparatus for generating a local signal illustrated in FIG. 4 is used, since a noise signal, etc., are removed by filtering and the like, when the RF signal is down-converted into an IF signal, spurious emissions can be fully eliminated by the filtering and the like, even though the spurious emissions are incurred by a switching operation in a process of generating the RF local signal. However, since the IF local signal is used in down-converting the IF signal into a digital signal, it is necessary to prevent the spurious emissions from occurring due to a switching operation in generating the IF local signal.

Therefore, in the wireless telecommunication system using the TDD scheme according to the present invention, the RF and IF local signals for transmission/reception are generated in a local unit. Accordingly, an apparatus for generating a local signal for wireless telecommunications (hereinafter, referred to as “local signal generating apparatus for wireless telecommunications”) is proposed as illustrated in FIG. 5 in order to overcome problems such that the spurious emissions are caused when the IF local signal is generated.

FIG. 5 is a block diagram illustrating an example in detail of a local signal generating apparatus for wireless telecommunications according to the present invention. The local signal generating apparatus for wireless telecommunications includes an IF local unit 500 and an RF local unit 600. The IF local unit 500 generates an IF local signal, distinguishes the generated IF local signal into signals for transmission and for reception, and outputs the distinguished IF local signals to the transmission path and to the receive path respectively. The RF local unit 600 generates an RF local signal, distinguishes the generated RF local signal into signals for transmission and for reception, and outputs the distinguished RF local signals to the transmission path and to the receive path respectively.

The IF local unit 500 includes a first frequency synthesizer 510, a first distributor 512, a third distributor 514, a set of attenuation resistors (R) 516₁ to 516ₙ (here, n corresponds to a natural number), a fifth distributor 518, and a Low-Pass Filter (LPF) 520. Herein, the first frequency synthesizer 510 generates the IF local signal. The first distributor 512 distributes the IF local signal into an IF local signal for transmission and an IF local signal for reception. The third distributor 514 distributes the IF local signal for reception into at least two signals, and outputs the distributed IF local signals. The attenuation resistors 516₁ to 516ₙ respectively adjust levels of output signals from the third distributor 514. The fifth distributor 518 distributes an input IF local signal into an IF local signal for transmission and an IF monitoring signal, and outputs the IF local signal for transmission and the IF monitoring signal. The LPF 520 removes harmonic components from the IF local signal.

The RF local unit 600 includes a second frequency synthesizer 610, a switch 612, a fourth distributor 614, a set of attenuation resistors (R) 616₁ to 616ₙ (here, n corresponds to a natural number), a sixth distributor 618, an isolator 620, an amplifier 622, a Temperature Pad (TP) 624, and a BPF 626. Herein, the second frequency synthesizer 610 generates the RF local signal. The switch 612 distributes the RF local signal into an RF local signal for transmission and an RF local signal for reception. The fourth distributor 614 distributes the RF local signal for reception into at least two signals, and outputs the distributed RF local signals. The attenuation resistors (R) 616₁ to 616ₙ respectively adjust the levels of the outputted signals from the fourth distributor 614. The sixth distributor 618 distributes an input RF local signal into an RF local signal and an RF monitoring signal, and outputs the RF local signal and the RF monitoring signal. The isolator 620 isolates a reflected wave caused by the sixth distributor 618. The amplifier 622 amplifies the RF local signal from the sixth distributor 618. The TP 624 compensates for the amplified RF local signal from the amplifier 622 according to temperature changes. The BPF 626 removes harmonic components from the RF local signal provided by the TP 624. Herein, it goes without saying that a configuration illustrated in FIG. 5 is included in the transceiver 27 in FIG. 2 showing the RAS of the wireless telecommunication system.

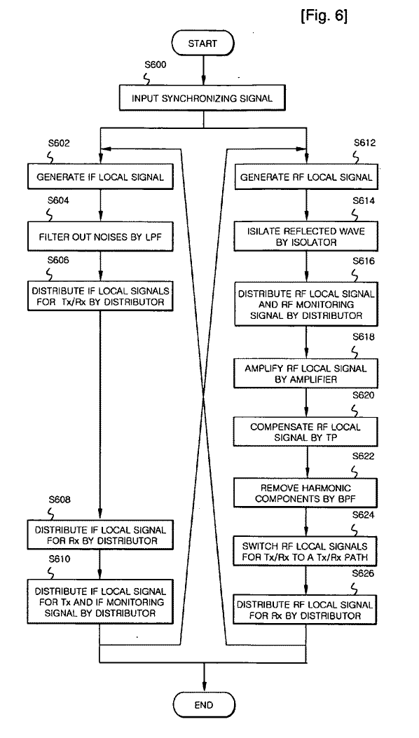

Hereinafter, a description will be more specifically described with reference to FIG. 6 of the local signal generating apparatus for wireless telecommunications according to the present invention configured as previously mentioned.

If a synchronizing signal having a specific frequency (e.g., a sine wave signal of 10 [MHz]) is input to the second distributor 700, the second distributor 700 distributes the received synchronizing signal into the first frequency synchronizer 510 of the IF local unit 500 and the second frequency synthesizer 610 of the RF local unit 600 as synchronizing signals (S600). Herein, even though it would be possible to provide the synchronizing signals to the first frequency synthesizer 510 and the second frequency synthesizer 610, respectively, since, in this case, it is necessary to configure a circuit for providing the synchronizing signals to the first frequency synthesizer 510 and the second frequency synthesizer 610, as proposed in the present invention, it can optimize a circuit configuration that the distributor distributes the received synchronizing signal to the first frequency synthesizer 510 and the second frequency synthesizer 610 on receiving the synchronizing signal. Herein, the synchronizing signal refers to a synchronizing signal provided to at least one among devices installed in an overall RAS system or in the RAS.

The first frequency synthesizer 510 generates an IF local signal correspond with the synchronizing signal provided from the second distributor 700 (S602), and the IF local signal generated from the first frequency synthesizer 510 is provided to the first distributor 512. At this time, it is desirable that the IF local signal generated and provided from the first frequency synthesizer 510 passes through the LPF 520 so as to remove harmonic components from the IF local signal (S604), and then the IF local signal whose harmonic components have been removed is input to the first distributor 512.

The IF local signal received to the first distributor 512 is distributed into an IF local signal for transmission and an IF local signal for reception (S606). The IF local signal for reception is distributed to at least two output ends (Rx_IF) by the third distributor 514 (S608). The IF local signal for transmission is outputted to at least one output end. Herein, it is needless to say that the number of transmission/receive output ends to which the IF local signal is outputted can be variously applied at the request of those skilled in the art. Furthermore, the at least two attenuation resistors 516₁ to 516ₙ (here, n corresponds to a natural number) for respectively adjusting the levels of the outputted IF local signals for reception are connected to the output ends (Rx_IF) of the IF local signal for reception, and the at least one attenuation resistor 516′ for adjusting the level of the provided IF local signal is installed on the output end (Tx_IF) of the IF local signal.

Also, the fifth distributor 518 connected between the first distributor 512 and the output end (Tx_IF), receives an IF local signal for transmission generated from the first distributor 512, and distributes the IF local signal to at least two output ends. A signal provided from the fifth distributor 518 is used as an IF local signal for transmission (Tx_IF), and the other signal provided from the fifth distributor 518 is used as a signal (IF M_S) necessary to monitor the IF local signal (S610).

Because the IF local signals for transmission/receive can be generated by a single first frequency synthesizer 510 according to the present invention as described above, the configuration of the apparatus for generating the local signal according to the present invention is optimized, and the size of the apparatus is not only made smaller, but also it can help to cut down on the cost of the apparatus. Above all, because the IF local signal for reception and the IF local signal for transmission are output by using the distributor, the spurious emissions due to the operation of the switch are prevented from occurring, and the characteristic of phase noise can be improved.

Meanwhile, the second frequency synthesizer 610 generates an RF local signal correspond with a synchronizing signal provided from the second distributor 700 (S612), and then, the RF local signal generated from the second frequency synthesizer 610 is input to the switch 612 operating in synchronization with transmission/receive periods between the PSS and the RAS.

The RF local signal input to the switch 612 is distributed into an RF local signal for transmission and an RF local signal for reception by a switching operation of the switch 612, and outputs the RF local signal for transmission and the RF local signal for reception (S624). The RF local signal for reception is distributed to at least two output ends (Rx_RF) by the fourth distributor 614 (S626), and the RF local signal for transmission is output to at least one output end (Tx_RF). Herein, it is needless to say that the number of transmission/receive output ends of the RF local signal can be variously applied at the request of those skilled in the art. Furthermore, the at least two attenuation resistors 616₁ to 616ₙ (here, n corresponds to a natural number) for respectively adjusting the levels of the outputted RF local signals for reception are installed on the output ends (Rx_RF) of the RF local signal for reception, and the at least one attenuation resistor 616′ for (respectively) adjusting the level of the outputted RF local signal for transmission is installed on the output end (Tx_RF) of the RF local signal for transmission.

Also, the sixth distributor 618 installed between the second frequency synthesizer 610 and the switch 612, receives an RF local signal provided from the second frequency synthesizer 610, and distributes the RF local signal to at least two output ends. A signal provided through any one of output ends of the sixth distributor 618 is input to the switch 612, and another signal provided through another output ends of the sixth distributor 618 is used as a signal (RF M_S) necessary to monitor the RF local signal (S616).

In the meantime, the isolator 620 installed between the second frequency synthesizer 610 and the sixth distributor 618 prevents a reflected wave caused by the sixth distributor 618 from flowing into the second frequency synthesizer 610 (S614). Furthermore, the amplifier 622, the TP 624, and the BPF 626 are installed between the sixth distributor 618 and the switch 612. The RF local signal outputted through any of the output ends of the six distributor 618 is amplified by the amplifier 622 (S618), and then, the TP 624 compensates for an amplified signal from the amplifier 622 according to temperature changes (S620). Next, the BPF 626 removes harmonic components from the RF local signal provided by the TP 624, and then, the RF local signal whose harmonic components are eliminated is input to the switch 612 (S622).

Since the RF local signals for transmission/receive can be generated by a single second frequency synthesizer 610 according to the present invention as previously described, as the configuration of the apparatus for generating the local signal according to the present invention is optimized, the size of the apparatus is not only made smaller, but also it can help to cut down on the cost of the apparatus.

Lastly, the local signal generating apparatus for wireless telecommunications according to the present invention is included in the transceiver of a fixed RAS, but, without being limited to this, it goes without saying that the local signal generating apparatus can be made smaller and then carried by a mobile RAS, a moving means such as a vehicle, etc., a PSS, etc. at the request of those skilled in the art.

While this invention has been described in connection with what is presently considered to be the most practical and preferred embodiment, it is to be understood that the invention is not limited to the disclosed embodiment and the drawings, but, on the contrary, it is intended to cover various modifications and variations within the spirit and scope of the appended claims.

1. An apparatus for generating a local signal in a wireless telecommunication system using a scheme of Time Division Duplex (TDD), the apparatus comprising:
an Intermediate Frequency (IF) local unit for generating an IF local signal; and
a Radio Frequency (RF) local unit for generating an RF local signal,
wherein the IF local unit comprises:
a first frequency synthesizer for generating the IF local signal; and
a first distributor for distributing the IF local signal into an IF local signal for transmission and an IF local signal for reception, and
wherein the RF local unit comprises:
a second frequency synthesizer for generating the RF local signal; and
a switch for distinguishing the RF signal into an RF local signal for transmission and an RF local signal for reception, and switching the RF local signal for transmission to a transmission path and the RF local signal for reception to a receive path.

2. The apparatus as claimed in claim 1, wherein the switch switching in synchronization with transmission/receive periods.

3. The apparatus as claimed in claim 1, which further comprises a second distributor for receiving a synchronizing signal, and distributing synchronizing signals to the first frequency synthesizer and the second frequency synthesizer.

4. The apparatus as claimed in claim 1, wherein the IF local unit further comprises a third distributor for distributing the IF local signal for reception to at least two output ends.

5. The apparatus as claimed in claim 1, wherein the IF local unit further comprises a fifth distributor for distributing the IF local signal for transmission into an IF local signal for transmission and an IF monitoring signal.

6. The apparatus as claimed in claim 1, wherein the IF local unit further comprises a Low-Pass Filter (LPF) for removing harmonic components from the IF local signal, and transmitting the IF local signal to the first distributor.

7. The apparatus as claimed in claim 1, wherein the RF local unit further comprises a fourth distributor for distributing the RF local signal for reception to at least two output ends.

8. The apparatus as claimed in claim 1, wherein the RF local unit further comprises a sixth distributor for distributing the RF local signal into an RF local signal which being provided to the switch and a RF monitoring signal.

9. The apparatus as claimed in claim 8, wherein the RF local unit further comprises:
an isolator for isolating a reflected wave, caused by the sixth distributor, from the second frequency synthesizer;
an amplifier for amplifying the RF local signal provided from the sixth distributor;
a Temperature Pad (TP) for compensating the amplified signal according to temperature changes; and
a Band-Pass Filter (BPF) for filtering the compensated signal off harmonic components, and transmitting a filtered signal to the switch.

10. A method for generating a local signal for a wireless telecommunication using a scheme of Time Division Duplex (TDD), the method comprising the steps of:
(a) converting an Intermediate Frequency (IF) signal having the Intermediate Frequency between the baseband and the Radio Frequency (RF) into an IF local signal;
(b) distributing the IF local signal into an IF local signal for transmission and an IF local signal for reception; and
(C) outputting the IF local signal for transmission to a Transmission (Tx) path during a Down Link (DL) in a TDD period, and outputting the IF local signal for reception to at least two Receive (Rx) paths during an Up Link (UL) in the TDD period.

11. The method as claimed in claim 10, wherein the step (a), the IF local signal is synchronized with an RF local signal in response to a synchronizing signal.

12. The method as claimed in claim 10, wherein the Rx paths comprise four output ends for reception, and the Tx path comprise one output end for transmission.

13. The method as claimed in claim 10, which further comprises the step of distributing the IF local signal for transmission into an IF local signal for transmission and an IF monitoring signal, wherein the step of distributing the IF local signal for transmission precedes step (b).

14. The method as claimed in claim 10, which further comprises a step of removing harmonic components from the IF local signal, wherein the step of filtering the IF local signal follows step (a).

15. A method for generating a local signal for a wireless telecommunication using a scheme of Time Division Duplex (TDD), the method comprising the steps of:
(a) converting a Radio Frequency (RF) signal into an RF local signal;
(b) switching an RF local signal for reception to a receive path during an Up Link (UL), and switching the RF local signal for transmission to a transmission path during a Down Link (DL); and
(c) distributing the RF local signal for reception to at least two Receive (Rx) paths during the UL, and outputting the RF local signal for transmission to a Transmission (Tx) path during the DL.

16. The method as claimed in claim 15, which further comprising the step of distributing the RF local signal into the RF local signal for transmission and the RF signal for reception by a switch operating in synchronization with transmission/receive periods.

17. The method as claimed in claim 15, wherein the RF local signal is generated by using a synchronizing signal of a system.

18. The method as claimed in claim 15, which further comprises the step of distributing the RF local signal into an RF local signal and a RF monitoring signal, wherein the step of distributing the RF signal follows step (a).

19. The method as claimed in claim 18, which further comprises a step of (a-1) isolating a reflected wave caused by the distributor, wherein step (a-1) follows step (a).

20. The method as claimed in claim 18, further comprising the steps of:
(a′-1) amplifying the RF local signal distributed by the distributor;
(a′-2) compensating the amplified signal according to temperature changes; and
(a′-3) filtering the compensated signal off harmonic components,
wherein steps (a′-1) to (a′-3) follow step (a).

21. A method for generating a local signal for wireless telecommunications of a Radio Access Station (RAS) system using a scheme of Time Division Duplex (TDD) using the same transmission/receive frequency, and having an Up Link (UL) in which the RAS receives data and a Down Link (DL) in which the RAS transmits data, the method comprising the steps of:
(a) converting, by a Radio Frequency (RF) synthesizer, an RF signal into an RF local signal in response to a synchronizing signal of the RAS system, and converting, by an Intermediate Frequency (IF) synthesizer, an IF signal having the Intermediate Frequency between the baseband and the Radio Frequency into an IF local signal, wherein the conversion of the RF signal into the RF local signal and the conversion of the IF signal into the IF local signal are implemented by the same local unit;
(b) switching, by a switch, the RF local signal to a receive path, and outputting the IF local signal to a receive path by way of a distributor during the UL in a TDD period, and switching the RF local signal to a transmission path, and outputting the IF local signal through a transmission path by way of a distributor during the DL in the TDD period;
(C) distributing, by a distributor, the RF local signal and the IF local signal respectively outputted to at least two receive paths during the UL in the TDD period, and outputting the RF local signal and the IF local signal respectively outputted to a transmission path during the DL in the TDD period.

22. A Radio Access Station (RAS) in a wireless telecommunication system using a scheme of Time Division Duplex (TDD), the RAS comprising:
an antenna for transmitting/receiving a Radio Frequency (RF) signal to/from a Portable Subscriber Station (PSS);
a front-end for processing transmission/receive signals transmitted/received via the antenna, and transmitting the receive signal to a transceiver;
the transceiver for generating an Intermediate Frequency (IF) local signal and an RF local signal, and up/down-converting the RF local signal and an the IF local signal, respectively, by an apparatus for generating a local signal which distributing, by a distributor, the generated IF local signal into an IF local signal for transmission and an IF local signal for reception, and outputting, by a switch, the RF local signal for transmission and the IF local signal for reception;
an amplifier for amplifying the transmission signal provided from the transceiver, and transmitting the amplified signal to the front-end; and
a channel control unit for controlling the transceiver, checking transmission/reception signals, and controlling a transmission channel.
